(19) United States
(12) Patent Application Publication
(10) Pub. No.: US 2018/0289001 A1
(43) Pub. Date: Oct. 11, 2018

(54) TREATING SEEDS, PLANTS, AND SOIL WITH ENCAPSULATED COMPOSITION

(71) Applicant: Battelle Memorial Institute, Columbus, OH (US)

(72) Inventors: Ramanathan S. Lalgudi, Westerville, OH (US); John Groome, London (GB)

(21) Appl. No.: 15/948,018

(22) Filed: Apr. 9, 2018

Related U.S. Application Data
(60) Provisional application No. 62/483,335, filed on Apr. 8, 2017.

(51) Int. Cl. A01N 25/28; A01N 25/04; A01N 53/00; A01N 63/00; C08L 23/08

(52) U.S. Cl. CPC A01N 25/28; A01N 25/04; A01N 57/16; A01N 63/00; C08L 23/08; A01N 53/00

(57) ABSTRACT

Coated seeds, plants, or soil are described. The seeds, plants or soil are coated with an encapsulated composition containing a plurality of capsules each comprising an amphiphilic material encapsulating an agrochemical, the encapsulated agrochemical having a release rate less than a release rate of unencapsulated agrochemical. The encapsulated agrochemical can be included in paint and applied to substrates such as concrete, polymer, polymer wood composites and metals for a slow release of insecticide.

### BACKGROUND OF THE INVENTION

This invention relates in general to encapsulation materials and methods, and in particular to agrochemicals encapsulated by amphiphilic materials.

The practice of protecting agrochemicals from an incompatible environment by encapsulation is well known. Encapsulation may be employed for a variety of reasons, including protecting agrochemicals from oxidation, preventing volatile losses, preventing chemical reaction or improving the handling characteristics of agrochemicals. The protective coating or shell is ruptured at the time of desired action of the ingredient. The rupturing of the protective shell is typically brought about through the application of chemical or physical stimuli such as pressure, shear, melting, response solvent action, enzyme attack, chemical reaction or physical disintegration.

A number of companies have worked on improvements in encapsulation materials, including Revolymer Limited (U.K.) as disclosed in their published international patent applications WO 2009/050203, WO 2011/064555, WO 2012/140442 and WO 2014/140550 A1; and Novozymes A/S (Denmark) as disclosed in WO 2016/023685.

There is still a need for further improvements in encapsulation materials, particularly in regards to the use of encapsulated agrochemicals.

### BRIEF DESCRIPTION OF THE DRAWINGS

FIG. 1 is a flow chart of one embodiment of the encapsulation of an agrochemical with a copolymer.

FIG. 2 is a schematic representation of an agrochemical being encapsulated in polymer micelles.

FIG. 3 is a graph of the particle size distribution of an encapsulation composition according to the invention, which is made as described in Example 2.

FIG. 4 is a graph of the particle size distribution of another embodiment of an encapsulation composition according to the invention, which is made as described in Example 3.

FIG. 5 is a graph of the particle size distribution of a further embodiment of an encapsulation composition according to the invention, which is made as described in Example 4.

FIG. 6 is a bar graph showing the results of a micellar disintegration study.

### DESCRIPTION OF THE INVENTION

One aspect of the present invention is the encapsulation of agrochemicals, including chemical and biological agrochemicals, useful as, for example, insecticides, herbicides, fungicides, nematicides, and biostimulants as a seed treatment or as applied to the soil or plants.

In particular, certain agrochemicals useful for seed or soil treatment are preferably encapsulated in accordance with the present invention because user exposure can be either toxic or induce chemical sensitivity in the user. Examples of active ingredients to preferably be encapsulated in accordance with the present invention are Tefluthrin, an agrochemical; and Chlorpyrifos, a crystalline organophosphate (also variously known by the tradenames Dursban, Lorsban, Bolton Insecticide, Nufos, Cobalt, Hatchet, and Warhawk). Other materials having known sensitivities are also proper subjects for such encapsulation.

Further, microbial biological control agents desirable encapsulated in accordance with the present invention for treatment of seeds (pre-treatment or in situ) or plants include a large number of such agents listed herein, as follows:

TABLE 1
Registered microbial biological control agents for augmentative biological
control in Australia (AUS), Brazil (BR), Canada (CA), European Union (EU),
Japan (J), New Zealand (NZ) and United States of America (USA)

| | Type^{b} of | Country/region | |
|---|---|---|---|
| Microorganism^{a} | organism | where approved | Target(s) |
| Adoxophyes orana GV V-0001 | V | EU, J | Summer fruit tortrix |
| Agrobacterium radiobacter | B | NZ (1975) | Crown gall |
| Agrobacterium radiobacter K1026 | B | USA | Crown gall |
| Agrobacterium radiobacter K84 | B | CA, J, USA | Crown gall |
| Alternaria destruens 059 | F | USA | Cuscuta spp. (dodder) |
| Ampelomyces quisqualis AQ10 | F | EU, USA | Powdery mildew |
| Anagrapha falcifera NPV | V | USA | Anagrapha falcifera |
| Anticarsia gemmatalis NPV | V | BR | Anticarsia gemmatalis |
| Aspergillus flavus NRRL 21882 | F | BR, USA | Aspergillus flavus |
| | | | mycotoxine |
| Aspergillus flavus AF36 | F | USA | Aspergillus flavus |
| | | | mycotoxine |
| Aureobasidium pullulans DSM | Y | EU, CA | Bacterial and fungal |
| 14940 and DSM 14941 | | | flower and foliar diseases |
| Autographa californica NPV | V | CA | Autographa californica |
| Bacillus amyloliquefaciens | B | CA, J, EU^{c}, | Seed treatment, soil borne |
| (formerly B. subtilis) MBI 600 | | NZ (2009, | diseases |
| | | 2012), USA | |
| Bacillus amyloliquefaciens AH2 | B | EU^{c} | Fungal soil diseases |
| Bacillus amyloliquefaciens AT-332 | B | J | Botrytis, powdery mildew |
| Bacillus amyloliquefaciens bs1b | B | NZ (2010) | Foliar diseases |
| Bacillus amyloliquefaciens PTA- | B | USA | Nematodes |
| 4838 | | | |
| Bacillus amyloliquefaciens | B | CA, EU, J, NZ | Seedling fungal pathogens |
| ssp. plantarum (syn. | | (2010) | |
| Bacillus subtilis var. | | | |
| amyloliquefaciens) D747 | | | |
| Bacillus cereus BP01 | B | USA | Foliar plant growth |
| | | | regulator |
| Bacillus firmus i-1582 | B | CA, EU, NZ | Nematodes |
| | | (2016) | |
| Bacillus licheniformis SB3086 | B | USA | Fungal foliar diseases |
| Bacillus mycoides J CX-10244 | B | CA, USA | Cercospora leaf spot on |
| | | | sugar beet |
| Bacillus pumilus GB34 | B | USA | Root diseases of soy |
| | | | beans |
| Bacillus pumilus QST 2808 | B | BR, EU, USA | Fungal foliar diseases |
| Bacillus subtilis ATCC 6051 | B | NZ (2012) | Fungal foliar diseases |
| Bacillus subtilis GB03 | B | CA, USA | Fungal diseases |
| Bacillus subtilis HAI-0404 | B | J | Foliar diseases |
| Bacillus subtilis IAB/BS03 | B | EU^{c} | Foliar fungal and |
| | | | bacterial diseases |
| Bacillus subtilis KT SB | B | NZ (2008) | Foliar diseases |
| Bacillus subtilis QST 713 | B | BR, CA, EU, J. | Fungal foliar diseases |
| | | NZ (2001), | |
| | | USA | |
| Bacillus subtilis var. | B | CA, EU^{c}, USA | Fungal foliar diseases |
| amyloliquefaciens FZB24 | | | |
| Bacillus subtilis Y 1336 | B | J | Botrytis, powdery |
| | | | mildew |
| Bacillus thuringiensis EG-7826 | B | BR | Lepidopteran caterpillars |
| Bacillus thuringiensis BMP 123 | B | BR | Lepidopteran caterpillars |
| Bacillus thuringiensis CryC | B | USA | Lepidopteran caterpillars |
| encapsulated in killed | | | |
| Pseudomonas fluorescens | | | |
| Bacillus thuringiensis CrylA(c) | B | USA | Lepidopteran caterpillars |
| and CrylC in killed | | | |
| Pseudomonas fluorescens | | | |
| Bacillus thuringiensis EG 2348 | B | BR, EU | Lepidopteran caterpillars |
| Bacillus thuringiensis SA-11 | B | BR, CA, EU | Lepidopteran caterpillars |
| Bacillus thuringiensis SA-12 | B | BR, CA, EU | Lepidopteran caterpillars |
| Bacillus thuringiensis Serotype H-14 | B | CA | Lepidopteran caterpillars |
| Bacillus thuringiensis ssp. Aizawai | B | CA | Lepidopteran caterpillars |
| Bacillus thuringiensis ssp. Aizawai | B | AUS (2000) | Lepidopteran caterpillars |
| Bacillus thuringiensis ssp. aizawai | B | EU, NZ | Lepidopteran caterpillars |
| ABTS-1857 | | (1999) | |
| Bacillus thuringiensis ssp. aizawai | B | USA | Lepidopteran caterpillars |
| NB200 | | | |
| Bacillus thuringiensis ssp. aizawai | B | USA | Lepidopteran caterpillars |
| GC-91 | | | |
| Bacillus thuringiensis ssp. aizawai | B | BR, EU | Lepidopteran caterpillars |
| GC-91 | | | |
| Bacillus thuringiensis ssp. | B | NZ (1995) | Lepidopteran caterpillars |
| aizawai/kurstaki | | | |
| Bacillus thuringiensis ssp. | B | CA | Beetles |
| galleriae SDS-502 | | | |
| Bacillus thuringiensis ssp. | B | USA | Mosquitoes |
| Israelensis | | | |
| Bacillus thuringiensis ssp. | B | USA | Mosquitoes |
| israelensis EG2215 | | | |
| Bacillus thuringiensis ssp. | B | CA, EU | Mosquitoes |
| israeliensis (serotype H-14) | | | |
| AM65-52 | | | |
| Bacillus thuringiensis ssp. kurstaki | B | AUS (1994), | Lepidopteran caterpillars |
| | | BR, EU, J, | |
| | | NZ, USA | |
| Bacillus Thuringiensis ssp. kurstaki | B | EU | Lepidoteran caterpillars |
| ABTS 351 | | | |
| Bacillus Thuringiensis ssp. kurstaki | B | EU | Lepidoteran caterpillars |
| PB 54 | | | |
| Bacillus Thuringiensis ssp. kurstaki | B | CA | Lepidoteran caterpillars |
| (All Strains) | | | |
| Bacillus thuringiensis ssp. kurstaki | B | AUS (1996) | Cotton bollworm |
| 3a, 3b var SA-12 | | | |
| Bacillus thuringiensis ssp. kurstaki | B | USA | Lepidoteran caterpillars |
| BMP123 | | | |
| Bacillus thuringiensis ssp. kurstaki | B | BR | Lepidoteran caterpillars |
| EG | | | |
| Bacillus thuringiensis ssp. kurstaki | B | USA | Lepidoteran caterpillars |
| EG 2348 | | | |
| Bacillus thuringiensis ssp. kurstaki | B | USA | Lepidoteran caterpillars |
| EG 2371 | | | |
| Bacillus thuringiensis ssp. kurstaki | B | USA | Lepidoteran caterpillars |
| EG7826 | | | |
| Bacillus thuringiensis ssp. | B | USA | Lepidopteran caterpillars |
| kurstaki EG7841 | | | |
| Bacillus thuringiensis kurstaki | B | USA | Lepidopteran caterpillars |
| evb-113-19 | | | |
| Bacillus thuringiensis ssp. | B | USA | Lepidopteran caterpillars |
| kurstaki encapsulated in killed | | | |
| Pseudomonas fluorescens | | | |
| Bacillus thuringiensis ssp. | B | NZ (1996) | Lepidopteran caterpillars |
| kurstaki h-3a, 3B hd1 | | | |
| Bacillus thuringiensis ssp. | B | NZ (2000) | Lepidopteran caterpillars |
| kurstaki h-3a, 3b, hd 263 | | | |
| Bacillus thuringiensis ssp. | B | NZ (1995) | Lepidopteran caterpillars |
| kurstaki h-3a, 3b, SA-11 | | | |
| Bacillus thuringiensis ssp. | B | AUS (2000), | Lepidopteran caterpillars |
| kurstaki HD-1 | | BR, CA | |
| Bacillus thuringiensis ssp. | B | AUS (2008) | Lepidopteran caterpillars |
| kurstaki SA-11 | | | |
| Bacillus thuringiensis ssp. | B | AUS (2005) | Cotton bollworm |
| kurstaki SA-12 | | | |
| Bacillus thuringiensis ssp. san | B | USA | Beetles |
| diego encapsulated in killed | | | |
| Pseudomonas fluorescens | | | |
| Bacillus thuringiensis ssp. | B | CA, EU | Beetles |
| tenebrionis NB 176 | | | |
| Beauveria bassiana 147 | F | EU^{c} | Red palm weevil, soft |
| | | | bodied insects |
| Beauveria bassiana 447 | F | USA | Ants |
| Beauveria bassiana ANT-03 | F | CA | Soft bodied insects |
| Beauveria bassiana ATCC | F | EU, NZ | Spidermites, whitefly, |
| 74040 | | (2013), | thrips, aphids |
| | | USA | |
| Beauveria bassiana CG 716 | F | BR | Whitefly, spidermites, |
| | | | beetles |
| Beauveria bassiana GHA | F | CA, EU, J | Whitefly, thrips, aphids |
| Beauveria bassiana HF23 | F | CA | Soft bodied insects |
| Beauveria bassiana IBCB 66 | F | BR | Whitefly, spidermites, |
| | | | beetles |
| Beauveria bassiana IMI389521 | F | EU^{c} | Beetles in stored grain |
| Beauveria bassiana k4b1 | F | NZ (2005) | Thrips |
| Beauveria bassiana k4b3 | F | NZ (2009) | Sucking insects |
| Beauveria bassiana | F | EU^{c} | Banana weevil, red palm |
| NPP111B005 | | | weevil |
| Beauveria bassiana PL63 | F | Br | Whitefly, spidermites, |
| | | | beetles |
| Beauveria bassiana PPRI 5339 | F | CA, EU^{c} | Soft bodies insects, |
| | | | caterpillars |
| Beauveria brongniartii NBL 851 | F | J | Long horn beetle etc. |
| Burkholderia (Pseudomonas) | Y | USA | Damping off diseases, |
| cepacia M54 | | | nematodes |
| Burkholderia (Pseudomonas) | Y | USA | Damping off diseases, |
| cepacia J82 | | | nematodes |
| Candida oleophila isolate I-182 | Y | USA | Post-harvest fungicide |
| Candida oleophila O | Y | EU | Post-harvest fungicide |
| Chondrostereum purpureum PFC | F | CA, USA | Inhibits |
| 2139 | | | sprouting/regrowth of |
| | | | shrubs and trees |
| Chromobacterium subtsugae | B | EU^{c} | Various insects and |
| PRAA4-1T | | | mites |
| Clavibacter michiganensis ssp. | BP | CA | Clavibacter |
| michiganensis | | | michiganensis ssp/ |
| bacteriophage | | | michiganenis |
| Colletotrichum gloeosporioides | F | USA | Northern jointvetch |
| f. sp. aeschynomene | | | (Aeschynomene |
| | | | Virginica) |
| Condylorrhiza vestigialis | NPV | BR | Condylorrhiza |
| | | | vestigialis (Braz. poplar |
| | | | moth) |
| Coniothyrium minitans | F | CA, EU, | Sclerotinia spp. |
| CON/M/91-08 | | USA | |
| Cydia pomonella GV (Mexican | V | AUS (2010), | Codling Moth |
| strain and various other strains) | | CA, EU, | |
| | | NZ (1999), | |
| | | USA | |
| Cydia pomonella GV V22 | V | AUS (2015) | Codling moth |
| (CPGV-V22) | | | |
| Erwinia carotovora CGE234 | B | J | Bacterial soft rot in |
| | | | potato and vegetables |
| Fusarium sp. L13 | F | EU^{c} | No information found |
| | | | about target |
| Gliocladium catenulatum J1446 | F | CA, EU, USA | Foliar fungal diseases |
| Gliocladium virens G-21 | F | USA | Damping off diseases |
| Helicoverpa armigera NPV | V | AUS (2002), | Helicoverpa ssp. |
| | | Br, EU, USA | |
| Helicoverpa zea NPV | V | AUS (1999), | Helicoverpa ssp. |
| | | Br, USA | |
| Homona magnanima GV | V | J | Tea leaf roller,, tTea |
| | | | tortorix |
| Isaria fumosorosea Apopka 97 | F | EU, J, USA | Soft bodied insects |
| (formely Paecilomyces | | | |
| fumosoroseus) | | | |
| Isaria fumosorosea Fe 9901 | F | CA, EU | Soft bodied insect |
| Lactobacillus casei LPT-111 | B | CA | Various weeds in lawns |
| Lactobacillus plantarum BY | B | J | Soft rot |
| Lactobacillus rhamnosus LPT-21 | B | CA | Various weeds in lawns |
| Lactococcus lactis ssp. cremoris | B | CA | Various weeds in lawns |
| M11/CSL | | | |
| Lactococcus lactis ssp. lactis | B | CA | Various weeds in lawns |
| LL102/CSL | | | |
| Lagenidium giganteum | F | USA | Mosquitoes |
| Lecanicillium lecanii (formerly | F | NZ (2012) | Thrips, whitefly, aphids, |
| Verticillium lecanii) K4V1 + | | | mealy bug, psyllid and |
| K4V2 | | | |
| Lecanicillium lecanii (formerly | F | NZ (2012) | Whitefly, thrips, aphids, |
| Verticillium lecanii) K4V2 | | | passion vine hopper |
| Lecanicillium muscarium | F | EU, J | Whitefly, thrips |
| (formerly Verticillium lecanii) | | | |
| Lymantri dispar NPV | V | CA, USA | Lymantra dispar |
| Metarhizium anisopliae | F | AUS | Redheaded pasture |
| | | | cockchafer |
| Metarhizium anisopliae | F | AUS | Greyback canegrub |
| Metarhizium anisopliae var. | F | AUS | Locusts |
| acridum | | | |
| Metarhizium anisopliae ESF1 | F | USA | Termites |
| Metarhizium anisopliae IBCB | F | Br | Leafhoppers |
| 348 | | | |
| Metarhizium anisopliae PL 43 | F | Br | Leafhoppers |
| Metarhizium anisopliae SMZ- | F | J | Aphids, thrips, whitefly |
| 2000 | | | |
| Metarhizium anisopliae var. | F | CA, EU, | Black vine weevil, thrips |
| anisopliae BIPESCO 5/F52 | | USA | |
| Metschnikowia fructicola NRRL | Y | EUc | Post-harvest diseases |
| Y-27328 | | | |
| Muscodor albus QST 20799 | F | USA | Bacteria, fungi and |
| | | | nematodes |
| Myrothecium verrucaria dried | F | USA | Nematodes |
| fermentation solids and solubles | | | |
| Neodiprion lecontei NPV | V | CA | Balsam fir sawfly |
| Neodiprion lecontei NPV | V | CA | Redheaded pine |
| | | | grragrasawfly |
| Nosema locustae | M | CA, USA | Grasshoppers, locusts, |
| | | | crickets |
| Orgyia pseudotsugata NPV | V | CA, USA | Douglas-fir tussock moth |
| Paecilomyces lilacinus | F | BR | Root knot nematodes |
| Paecilomyces lilacinus 251 | F | EU | Root knot nematodes |
| Paecilomyces tenuipes T1 | F | J | Whitefly, aphids, |
| | | | powdery mildew |
| Pantoea agglomerans C9-1 | B | CA, USA | Fire blight in apples and |
| | | | pears |
| Pantoea agglomerans E325 | B | CA | Fire blight in apples and |
| | | | pears |
| Pantoea agglomerans p10c | B | NZ (2006) | Fire blight in apples and |
| | | | pears |
| Pasteuria nishizawae Pn1 | B | CA, EU^{c}, | Nematodes Heterodera, |
| | | USA | Globodera) |
| Pepino mosaic virus CH2 | V | EU | Pepino mosaic virus |
| isolate 1906 | | | |
| Pepino Mosaic Virus isolate VC 1 | V | EU^{c} | Pepino mosaic virus |
| Pepino Mosaic Virus isolate VX 1 | V | EU^{c} | pepino mosaic virus |
| Phlebiopsis gigantea (several | F | EU | Root run |
| strains) | | | (Heterobasidion |
| | | | annosum) in conifers |
| Phlebiopsis gigantea VRA 1992 | F | CA | Root run |
| | | | (Heterobasidion |
| | | | annosum) in conifers |
| Phoma macrostoma | F | CA | Broadleaf weeds in turf |
| | | | grass |
| Phytophthora palmivora MWV | F | USA | Strangler vine (Morenia |
| | | | orderata) |
| Plodia interpunctella granulosis | V | USA | Plodia interpunctella |
| virus | | | |
| Pochonia chlamydosporia PC10 | F | BR | Nematodes |
| Pseudomonas aureofaciens Tx-1 | B | USA | Fungal diseases in turf |
| | | | grass |
| Pseudomonas chlororaphis 63-28 | B | USA | Pythium spp., |
| | | | Rhizoctonia solani, |
| | | | Fusaium oxysporum |
| Pseudomonas chlororaphis | B | EU | SSeed-borne pathogens |
| MA342 | | | on barley and oats |
| Pseudomonas fluorescens G 7090 | B | J | Bacterial and black rot |
| | | | in lettuce/cabbage |
| Pseudomonas fluorescens 1629RS | B | USA | Frost prevention in |
| | | | fruits, almond, potato, |
| | | | tomato |
| Pseudomonas fluorescens A506 | B | CA, USA | Frost prevention in |
| (syn. 006418) | | | fruits, almond, potato, |
| | | | tomato |
| Pseudomonas fluorescens CL145A | B | CA | Zebra mussel |
| Pseudomonas rhodesiae HAI-0804 | B | J | Bacterial diseases in |
| | | | citrus, plus peach, plum |
| Pseudomonas sp. DSMZ 13134 | B | EU | Rhizoctonia solani in |
| | | | potato |
| Pseudomonas syringae 742RS | B | USA | Frost prevention in |
| | | | fruits, almond, potato, |
| | | | tomato |
| Pseudomonas syringae ESC 10 | B | CA, USA | Post-harvest diseases in |
| | | | various fruits |
| Pseudomonas syringae ESC-11 | B | USA | Post-harvest diseases in |
| | | | various fruits |
| Pseudozyma flocculosa PF-A22 UL | F | EU^{c}, USA | Powdery mildew on |
| | | | roses and cucumbers |
| Puccinia thlaspeos | F | USA | Isatis tinctoria, dyer's |
| | | | woad |
| Purpureocilium lilacinum PL 11 | F | EU^{c} | Nematodes |
| Pythium oligandrum M1 | F | EU | Fungal diseases in |
| | | | cereals and oil seed rape |
| Saccharomyces cerevisiae extract | Y | USA | Bacterial diseases |
| hydrolysate | | | |
| Saccharomyces cerevisiae LAS02 | Y | EU | Fungal diseases in fruits |
| Sclerotinia minor IMI 3144141 | F | CA | Dandelion in turf |
| Serratia entomophila 626 | B | NZ (1994) | Grass grubs |
| Spodoptera exigua NPV | V | EU, USA | Spodoptera exigua (beet |
| | | | army worm) |
| Spodoptera littoralis NPV | V | EU | Spodoptera littoralis |
| | | | (cotton leaf worm |
| Streptomyces acidiscabies RL- | B | CA | Dandelion on turf grass |
| 110T | | | |
| Streptomyces griseoviridis K61 | B | CA, EU, USA | Fungal soil diseases in |
| | | | vegetables, ornamentals |
| Streptomyces lydicus ATCC | B | NZ (2013) | Soil borne and foliar |
| 554456 | | | diseases |
| Streptomyces lydicus WYEC 108 | B | CA, EU, NZ | Soil borne and foliar |
| | | (2009), USA | diseases |
| Talaromyces flavus SAY-Y-94-01 | F | J | Fungal and bacterial |
| | | | diseases |
| Trichoderma asperellum | F | EU | Fungal soil diseases in |
| (formerly T. harzianum) ICC012 | | | vegetables, ornamentals |
| Trichoderma asperellum | F | EU | Fungal soil diseases in |
| (formerly T. viride) T25 | | | vegetables, ornamentals |
| Trichoderma asperellum | F | EU | Fungal soil diseases in |
| (formerly T. harzianum) TV1 | | | vegetables, ornamentals |
| Trichoderma asperellum SF 04 | F | BR | Damping off, |
| (URM) 5911 | | | Sclerotinia sclerotiorum |
| Trichoderma asperellum T211 | F | BR | Damping off, |
| | | | Sclerotinia sclerotiorum |
| Trichoderma asperellum T34 | F | CA, EU | Fungal soil diseases in |
| | | | vegetables, ornamentals |
| Trichoderma atroviridae SKT-1 | F | J | Bacterial seedling blight |
| | | | and grain rot, seedling |
| | | | fungal blight |
| Trichoderma atroviride (5 strains) | F | NZ (1991) | Wound pathogens |
| Trichoderma atroviride (formerly | F | EU | Fungal soil diseases in |
| T. harzianum) IMI 206040 | | | vegetables, ornamentals |
| Trichoderma atroviride (formerly | F | EU | Fungal soil diseases in |
| T. harzianum) T11 | | | vegetables, ornamentals |
| richoderma atrovirde ag1, ag2, | F | NZ (1987) | Wound pathogens |
| ag3, ag5, ag11, ag15 | | | |
| Trichoderma atroviride I-237 | F | EU | Wound pathogens and |
| | | | fungal diseases soil |
| | | | diseases |
| Trichoderma atroviride lu132 | F | NZ (2004) | Foliar diseases |
| Trichoderma atroviride SC1 | F | EU | Wound pathogens |
| Trichoderma gamsii (formerly | F | EU | Fungal soil diseases in |
| T. viride) ICC080 | | | vegetables, ornamentals |
| Trichoderma hamatum TH382 | F | USA | Fungal soil diseases in |
| | | | vegetables, ornamentals |
| Trichoderma harzianum | F | AUS (2004) | Eutypa dieback in |
| | | | grapes |
| Trichoderma harzianum KRL-AG2 | F | CA, EU, USA | Fungal soil diseases in |
| (syn. T22) | | | vegetables, ornamentals |
| Trichoderma harzianum ESALQ- | F | BR | Damping off, |
| 1306 | | | Sclerotinia sclerotiorum |
| Trichoderma harzianum IBL F006 | F | BR | Damping off, |
| | | | Sclerotinia sclerotiorum |
| Trichoderma harzianum ITEM 908 | F | EU | Soil borne diseases |
| Trichoderma harzianum T-39 | F | USA | Fungal soil diseases in |
| | | | vegetables, ornamentals |
| Trichoderma polysporum ATCC | F | USA | Wound pathogens |
| 20475 | | | |
| Trichoderma polysporum IMI | F | EU | Botrytis cinerea, |
| 206039 | | | Chondrostereum |
| | | | purpureum |
| Trichoderma stromaticum | F | BR | Witch's broom |
| CEPLAC 3550 | | | |
| Trichoderma virens G-41 | F | CA | Fungal soil diseases in |
| | | | vegetables, ornamentals |
| Trichoderma viride ATCC 20476 | F | USA | Wound pathogens |
| Typhula phacorrhiza 94671 | F | CA | Snow molds in turf |
| Ulocladium oudemansii U3 | F | NZ (2004) | Foliar diseases, |
| | | | Pseudomonas syringae |
| Verticillium albo-atrum (formerly | F | CA, EU, USA | Dutch elm disease |
| V. dahliae) WCS850 | | | |
| Xanthomonas campestris pv. | BP | USA | Xanthomonas |
| Vesicatoria bacteriophage | | | campestris pv. |
| | | | vesicatoria |

Information obtained from (AUS) https://portal.apvma.gov.au/pubcris, (BR) http://extranet.agricultura.gov.br/agrofit_cons/principal_ agrofit_cons, (CA) http://pr-rp.hc-sc.gc.ca/ls-re/result-eng.php?p_search_label, (EU) http://ec.europa.eu/food/plant/pesticides/eu-pesticides-database/public/? event=homepage&language=EN, (J) Japan Plant Protection Association, (NZ) https://eatsafe.nzfsa. govt.nz/web/public/acvm-register, (USA) https://iaspub.epa.gov/apex/pesticides/f?p=chemicalsearch:1
^{a}Strain numbers if available
^{b}B bacterium, BP bacteriophage, F fungus, Y yeast, V virus
^{c}Pending in the EU

See the publication by van Lenteren, J. C., Bolckmans, K., Köhl, J. et al. BioControl (2017). Registered microbial biological control agents for augmentative biological control in Australia (AUS), Brazil (BR), Canada (CA), European Union (EU), Japan (J), New Zealand (NZ) and United States of America (USA)[Table]. doi:10.1007/s10526-017-9801-4. http://rd.springer.com/article/10.1007%2Fs10526-017-9801-4. The article containing this table is distributed under the terms of the Creative Commons Attribution 4.0 International License (http://creativecommons.org/licenses/by/4.0/). The table name has been edited from “Table 3” to “Table 1” for the purposes of this patent application.

Biological control using invertebrates and microrganisms: plenty of new opportunities, van Lenternen et al., BioControl (2017) doi:10.1007/s10526-017-9801-4, describes methods and materials used to reduce pests, and is incorporated herein by reference in its entirety. Advances in plant growth-promoting bacterial inoculant technology: formulations and practical perspectives (1998-2013), Bashan et al, Plant Soil (2014) 378:1-33, describes methods and materials of plant inoculation, and is incorporated herein by reference in its entirety. Microbial inoculation of seed for improved crop performance: issues and opportunities, O'Callaghan, Appl. Microbiol. Biotechnol. (2016) 100:5729-5746, describes methods and materials of seed and soil inoculation, and is incorporated herein by reference in its entirety. U.S. Pat. No. 5,876,739 describes methods and material for coating seeds with insecticides, and is incorporated herein by reference. Oils as adhesives for seed inoculation and their influence on the survival of Rhizobium spp. And Bradyrhizobium spp. On inoculated seed, Hoben et al., World J. Microbiology and Biotechnology, May 1991, Vol. 7, Issues 3, pp. 324-330 describes materials and methods used in seed inoculation, and is incorporated herein by reference in its entirety. Wax Powders and Dispersions for Seed Coatings, Product Application Bulletin (Rev. March/2015) of Micro Powders, Inc. describes materials used in seed coatings, and is incorporated herein by reference in its entirety.

The amphiphilic materials of the present invention may also be advantageously applied to seeds, plants and soil, including but not limited to application as particles, suspended particle formulations, slurries, or emulsions. In addition, additives or adjuvants may be used to enhance sticking ability of the material, such as addition of solvents such as alcohol, or glycerin, gum arabic, waxes, commercially available stickers, or other binders; and/or adjuvants such as surfactants, oils (e.g. mineral, peanut, soybean), and salts.

The encapsulation composition comprises a plurality of capsules, each capsule comprising an amphiphilic material encapsulating an agrochemical. The encapsulated agrochemical has a release rate less than a release rate of unencapsulated agrochemical.

In a particular embodiment, the encapsulating materials have well-balanced hydrophilic and hydrophobic chemical moieties that are useful for encapsulating an agrochemical.

The addition of materials with well-balanced hydrophilic and hydrophobic moieties to an agrochemical results in the encapsulation of the agrochemical via association of the amphiphilic materials onto the agrochemical. The association of the material onto the agrochemical may be driven by one or a combination of noncovalent forces such as dipole, hydrogen bonding, van der Waals, electrostatic, cation-pi electron interaction, or hydrophobic effects.

The amphiphilic material is a material composed of hydrophilic and hydrophobic portions or parts, which in certain embodiments are hydrophilic and hydrophobic sections or blocks. In certain embodiments involving block copolymers or surfactants useful for forming micelles, the amphiphilic material has a hydrophilic-lipophilic balance (HLB) within a range of from about 1 to about 20, or from about 11 to about 20, or from about 14 to about 18.

The hydrophilic portion anchors the encapsulated agrochemical, and the hydrophobic portion forms a shell wall of the capsule.

In certain embodiments, the amphiphilic material is a polymer, and more particularly, a copolymer such as a graft copolymer or a block copolymer.

In some non-limiting examples, the amphiphilic material may be included in one or more of the following classes of materials: a graft copolymer, a modified N,N,N′,N′-Tetrakis(2-hydroxypropyl)ethylenediamine, a cationic nanoparticle, a diblock or triblock copolymer, an ionic or nonionic surfactant, a low surface energy silica, a Guerbet ester, or a poly(stearyl methacrylate-co-acrylic acid).

For example, the amphiphilic material may be one or more of the following:
a non-ionic graft copolymer, such as poly(laurylmethacrylate)-g-polyethylene oxide (PLMA-g-PEG) (50:50, 75:25) or hydrophobically modified starch;
a material prepared by modification of N,N,N′,N′-Tetrakis(2-hydroxypropyl)ethylenediamine with trimethyl silyl chloride, with epoxy, or with a fluorinated epoxy mixture of poly(dimethyl siloxane)-amine (PDMS-amine) with fluoro trichlorosilane 1% siloxane/N-alkyl emulsion;
a material prepared by modification of epoxy functional terminated polyethylene oxide, with amine functional terminated poly(dimethyl siloxane) (PDMS-PEO-PDMS)
a cationic nanoparticle, such as a cationic nanoparticle prepared as described in the U.S. Pat. No. 9,000,203 by a sol-gel condensation of 3-aminopropyl trimethoxy silane and tridecafluoro-1,1,2,2-tetrahydrooctyl triethoxysilane.
a cationic nanoparticle, such as a cationic nanoparticle prepared as described in the U.S. Pat. No. 9,000,203 by a sol-gel condensation of 3-aminopropyl trimethoxy silane and a non-bioaccumulating fluorosilane such as trimethoxy(3,3,3-trifluoropropyl)silane
a non-ionic triblock polymer obtained by reacting monomethoxy terminated poly ethylene oxide with heptadecane dicarboxylic acid methyl ester such as C19 di-PEG;
a non-ionic triblock polymer obtained by reacting monohydroxyl terminated poly ethylene oxide with heptadecane dicarboxylic acid such as C19 di-PEG
a heptadecane carboxylic acid ester salts such as C19 di-acid salts with, Na+, K+, or Ca 2+ ions;
a tert-octyl phenol derivative of sulfonated dichloro diphenyl sulfone, such as

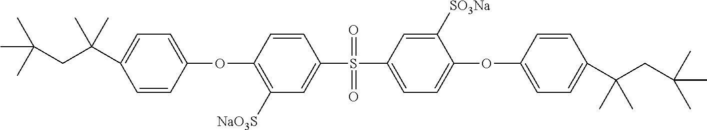

or a nonyl phenol derivative of sulfonated dichloro diphenyl sulfone,
or a poly(dimethyl siloxane) derivative of sulfonated dichloro diphenyl sulfone;
a low surface energy nonionic surfactant, such as isostearic acid-g-PEG;
a low surface energy graft copolymer, such as isostearic acid PEG triblock ester or isostearic acid-ester-co-PEG-methacrylate;
a low surface energy silica, such as isostearic acid ester silica;
a Guerbet ester, such as a highly branched tri-isostearic acid citrate ester;
a poly(stearyl methacrylate co acrylic acid), such as poly(stearyl methacrylate)-co-acrylic acid (PSMA-co-AA) 80:20;
a poly(stearyl methacrylate co N,N′-dimethylamino ethyl methacrylate, NN-DMEA), such as poly(stearyl methacrylate)-co-NN-DMEA (PSMA-co-PNNDMEA) 50:50;
a non-ionic diblock copolymer prepared by reacting mono hydroxy polyethylene oxide with 1-bromo octadecane;
a nonionic triblock copolymer prepared by reacting di hydroxy polyethylene oxide with 1-bromo octadecane;
a non-ionic diblock copolymer prepared by reacting mono hydroxy polyethylene oxide with linolenic acid; or
a non-ionic diblock copolymer prepared by reacting mono hydroxy polyethylene oxide with linoleic acid.

By cationic non-bio accumulating fluoropolymer, we mean a fluoropolymer with less than a 6 fluorocarbon chain. By low surface energy, we mean the surface energy is less than about 20 dynes/cm.

The encapsulated agrochemical can be liquid, solid, gas, or combinations thereof. Some non-limiting examples of agrochemicals are allethrin, permethrin, transfluthrin, tefluthrin, metofluthrin, fenfluthrin, kadethrin, neopynamins, prallethrin, vapothrin, esbiothrin, dichlovos, deltamethrin, and cypermethrin. The solvent used to dissolve the amphiphilic material should be immiscible with the solvent used to dissolve the active ingredient. For example, if the pyrethroid to be encapsulated is soluble in water (e.g., a water soluble functional polymer binder, such as an amino functional polymer such as polyethylene imine), then an organic solvent is used to dissolve the amphiphilic material, and water to dissolve the active ingredient.

The agrochemical may be encapsulated by the amphiphilic material by any suitable method. Some encapsulation techniques include, but are not limited to, dispersion, suspension, emulsification, and coating via conventional and electrostatic spray.

When the agrochemical is a solid or a liquid, it can be mixed in a solution of the amphiphilic material. The amphiphilic material forms a coating around the solid or liquid particles. In some cases, the agrochemical can be dissolved in a solvent before being mixed into the solution of amphiphilic material. The solvent used to dissolve the amphiphilic material should be immiscible with the solvent used to dissolve the agrochemical. For example, if the pyrethroid to be encapsulated is soluble in organic solvent (e.g., transfluthrin), then water is used to dissolve the amphiphilic material, and organic solvent to dissolve the agrochemical.

Solid or liquid agrochemicals should be sparingly soluble in the liquid used for the solution of the amphiphilic material. By sparingly soluble, we mean the solubility of the solute is less than about 3 g in 100 ml of the liquid. Gases can be encapsulated by bubbling the gas through the solution containing the amphiphilic material. The capsules can be nanocapsules and/or microcapsules. The capsules are typically in the range of about 10 nm to about 500 μm, or about 0.1 μm to about 100 μm, or about 1 μm to about 50 μm.

In some embodiments, the capsules are stable at alkaline pH.

In addition to the amphiphilic material, an additional surfactant (or co-surfactant) can be added to the mixture. Examples of co-surfactants include, but are not limited to, Sodium dodecyl sulfate, Sodium dodecylbenzenesulfonate, Sodium laureth sulfate, Sodium lauroyl sarcosinate, Sodium myreth sulfate, Sodium nonanoyloxybenzenesulfonate, Sodium stearate, Sulfolipid, Benzalkonium chloride, Benzyldodecyldimethylammonium bromide, Cetylpyridinium chloride, Dimethyldioctadecylammonium bromide, Dodecyltrimethylammonium bromide, Hexadecylpyridinium chloride, Tridodecylmethylammonium chloride

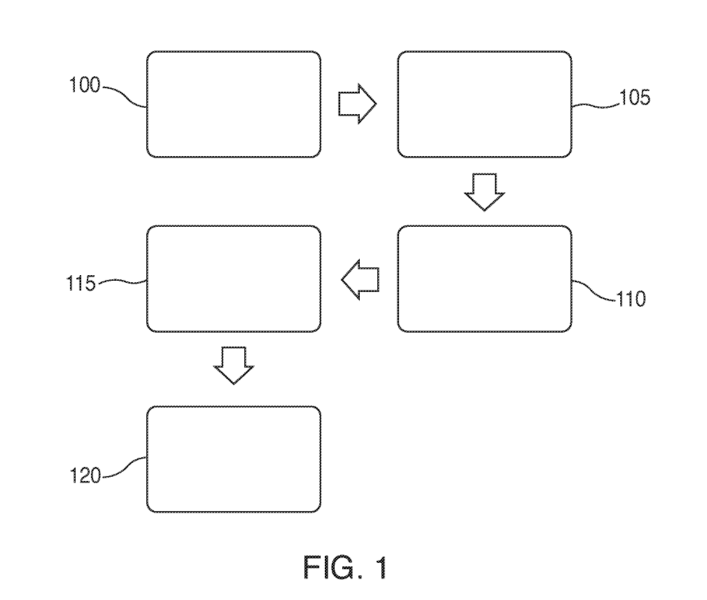

FIG. 1 is a flow chart of the encapsulation of an agrochemical with an amphiphilic material. In step 100, an agrochemical is suspended in a solvent. In step 105, amphiphilic material is added. In step 110, in some cases, the amphiphilic material forms micelles. In step 115, if micelles are formed, the micelles are deposited onto the agrochemical with the amphiphilic material. Otherwise, the amphiphilic material encapsulates the agrochemical without forming micelles. The product can then be isolated in step 120.

In certain embodiments, the amphiphilic material is an amphiphilic polymer capable of forming a micelle around the agrochemical when the capsule is dispersed in a liquid.

Micelles form only when the concentration of the polymer is greater than the critical micelle concentration (CMC). In certain embodiments, capsules have a CMC within a range of from about 0.0001 wt % to about 50 wt %. In addition, micelles only form when the temperature is above the critical micelle temperature (CMT) (also known as the cloud point or Krafft temperature). The CMT depends on a number of factors including the molecular weight of the polymer, the ratio of the hydrophobic portion to the hydrophilic portion, and functionality of the hydrophilic moiety. In general, the higher the amount of the hydrophobic portion, the higher the critical micelle temperature.

In general, block copolymers having a number average molecular weight less than 100,000 kD will form micelles. Examples of amphiphilic polymers forming micelles include, but are not limited to, PEO-PPO-PEO, PEO-PPO, PDMS-PEO-PDMS, PDMS-PEO, C19-diPEG, diblock copolymer prepared by reacting mono hydroxy polyethylene oxide with 1-bromo octadecane, nonionic triblock copolymer prepared by reacting di hydroxy polyethylene oxide with 1-bromo octadecane, C19 dicarboxylic acid salts, tert-octyl phenol derivative of sulfonated dichloro diphenyl sulfone, nonyl phenol derivative of sulfonated dichloro diphenyl sulfone, and poly(dimethyl siloxane) derivative of sulfonated dichloro diphenyl sulfone.

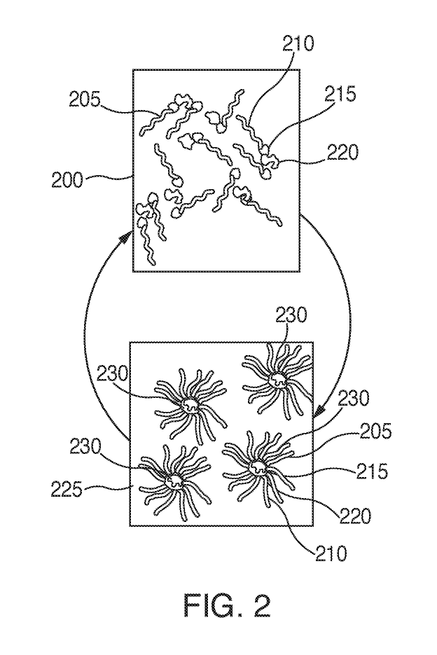

FIG. 2 is a schematic representation of the encapsulation of an agrochemical in amphiphilic micelles. As shown, in the first step 200, an amphiphilic material 205 is dispersed in a solvent, such as water. The amphiphilic material 205 has a hydrophilic segment 210 and a hydrophobic segment 215. The hydrophobic segment 215 of the amphiphilic material is adsorbed onto the agrochemical 220.

Above the CMC and CMT of the amphiphilic material 205 as shown in the second step 225, the amphiphilic material 205 forms micelles 230 around the agrochemical 220. The agrochemical 220 is encapsulated inside a hydrophobic core of the micelle 230 formed by the hydrophobic segment 215 of the amphiphilic material 205. The hydrophilic segment 210 of the amphiphilic material 205 extends radially outward and forms the shell of the micelle 230.

When the agrochemical is transfluthrin, a preferred amphiphilic material is PEO-PPO-PEO.

The encapsulated composition is coated on seeds, plants, or soils. The coating can be accomplished using any suitable coating process. Processes suitable for coating seeds include, but are not limited to, immersion, spraying and electrodeposition. Processes suitable for coating plants and soil include, but are not limited to, spraying.

One or more additional ingredients useful for formulating the product can be included. Additional ingredients include, but are not limited to, solvents, gum Arabic, waxes, commercially available stickers, binders, surfactants, oils, and salts.

The amphiphilic material should be capable of forming a film onto the seed, plant, or soil when applied and dried so that they are not tacky.

Some non-limiting examples of categories of products are pesticides, weedicides and fungicides.

In other embodiments, the encapsulated agrichemical can be included in paint and applied to substrates such as concrete, polymer, polymer wood composites and metals for a slow release of insecticide.

The release rate of active ingredient from the encapsulation composition of the present invention was determined by gravimetric analysis. A fabric (1sq.inch) was coated with the encapsulation composition and dried at room temperature to remove excess water and toluene. The coated fabric was kept under a controlled atmosphere (70 degree F. and 68% relative humidity), and its weight was monitored and recorded as a function of time. The release rate was calculated using the following equation:

$$K = - \frac{Δ m}{Δ t}$$

Where, K is the release rate, Δm is difference in mass and Δt is the difference in time. A similar procedure would be used to determine the release rate of the agrochemical from seeds, plants, soil, and the other substrates described above.

Hereinafter, the present invention is described with reference to specific examples, but it is not to be limited thereto.

### Example 1

Screening of Amphiphilic Materials for Encapsulation:

In the first step, the amphiphilic material is dissolved in water. The amphiphilic materials are commercially available products (Pluronic®) from BASF, as shown in the table below.

In the second step, the pyrethroid, transfluthrin, was dissolved in a large amount in toluene.

In the third step, the mixture obtained from second step is added to the mixture obtained from first step to form the pyrethroid encapsulated in the amphiphilic material.

The release rate of the pyrethroid from the capsules is controlled by a number of factors. One is the amount of amphiphilic material used in step 1. Higher amounts of amphiphilic material in step 1 result in decreased release rates of the pyrethroid. The release rate of the pyrethroid from the capsules is further controlled by the CMC of the amphiphilic material used in step 1. The higher the CMC of the amphiphilic material in step 1, the lower the release rate of the pyrethroid. The release rate of the pyrethroid from the capsules is further controlled by the ratio of organic solvents to the pyrethroid in step 2. The higher the ratio of organic solvents to the pyrethroid in step 2, the lower the release rate of the pyrethroid.

| | | | | | CMC |
|---|---|---|---|---|---|
| Copolymer | MW | No. of PO | No. of EO | HLB | (wt %) |
| L35 | 1900 | 16.38 | 21.59 | 19 | 1.0 |
| L43 | 1850 | 22.33 | 12.61 | 12 | 0.4 |
| L64 | 2900 | 30.00 | 26.36 | 15 | 0.14 |

### Example 2

In the first step, an aqueous solution of 5.6 wt % poly(ethylene oxide)-block-poly(propylene oxide)-block-poly(ethylene oxide) (PEO-PPO-PEO) (Pluronic® L64 (BASF)) was prepared by mixing 23.7 g of the block co-polymer in 400 g water (5 wt %). The solution was mixed for 3 hr using a magnetic stirrer at 300 rpm.

In the second step, 11.3 g of transfluthrin (TF) was dissolved in 15.8 g of toluene.

In the third step, the mixture obtained from the second step was added to the mixture obtained from the first step at room temperature to form the pyrethroid encapsulated in the amphiphilic material.

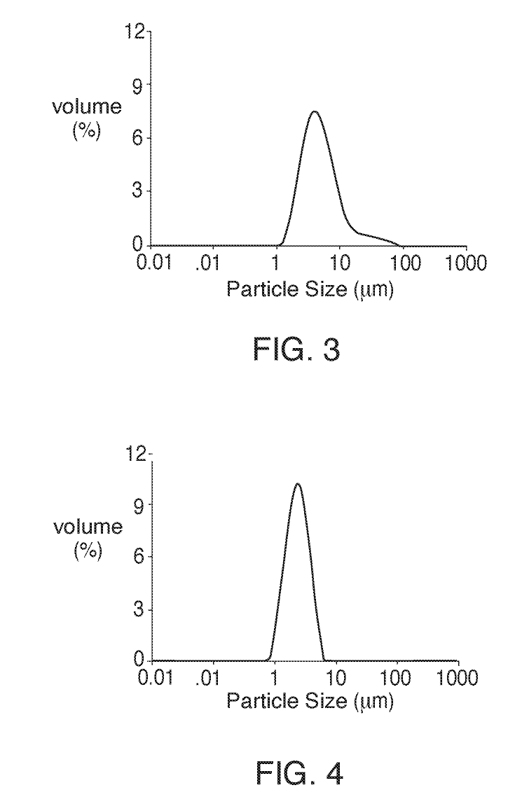

The product obtained from third step was characterized for particle size using dynamic-light-scattering (DLS, Master sizer 2000, Malvern). Formation of 3 μm droplet size with uniform drop-size-distribution was observed, as shown in FIG. 3.

The release rate of the transfluthrin as determined by the gravimetric method was found to be ≤0.2 mg/day.

### Example 3

In the first step, an aqueous solution of 5.7 wt % poly(ethylene oxide)-block-poly(propylene oxide)-block-poly(ethylene oxide) (PEO-PPO-PEO) (Pluronic® L64 (BASF)) was prepared by mixing 24.1 g of the block co-polymer in 400 g water (5 wt %). The solution was mixed for 3 hr using a magnetic stirrer at 300 rpm.

In the second step, 13.48 g of transfluthrin (TF) was dissolved in 74.8 g of toluene.

In the third step, the mixture obtained from the second step was added to the mixture obtained from the first step at room temperature to form the pyrethroid encapsulated in the amphiphilic material.

The product obtained from third step was characterized for particle size using dynamic-light-scattering (DLS, Master sizer 2000, Malvern). Formation of 3 μm droplet size with uniform drop-size-distribution was observed, as shown in FIG. 4.

The release rate of the transfluthrin as determined by the gravimetric method was found to be ≤0.4 mg/day.

### Example 4

In the first step, an aqueous solution of 7.1 wt % poly(ethylene oxide)-block-poly(propylene oxide)-block-poly(ethylene oxide) (PEO-PPO-PEO) (Pluronic® L64 (BASF)) was prepared by mixing 30.8 g of the block co-polymer in 400 g water (5 wt %). The solution was mixed for 3 hr using a magnetic stirrer at 300 rpm.

In the second step, 18.48 g of transfluthrin (TF) was dissolved in 289.8 g of toluene.

In the third step, the mixture obtained from the second step is added to the mixture obtained from the first step at room temperature to form the pyrethroid encapsulated in the amphiphilic material.

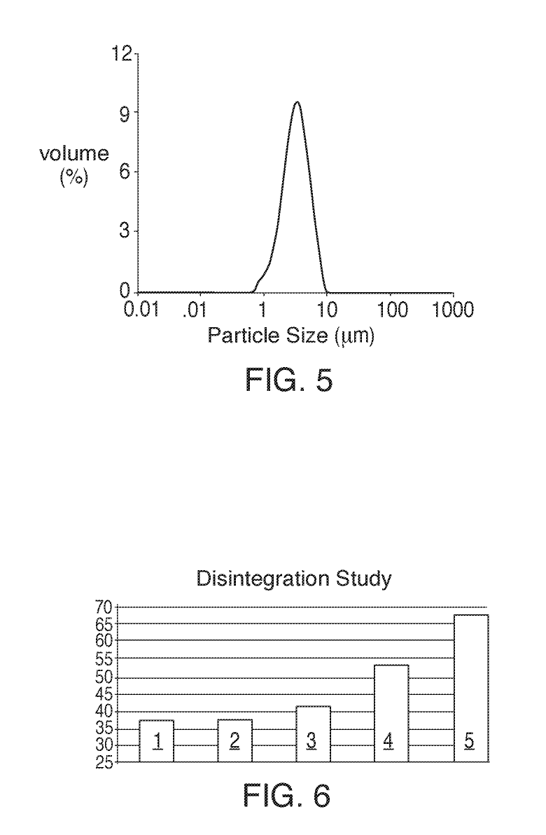

The product obtained from third step, was characterized for particle size using dynamic-light-scattering (DLS, Master sizer 2000, Malvern). Formation of 3 μm droplet size with uniform drop-size-distribution was observed, as shown in FIG. 5.

The release rate of the transfluthrin as determined by the gravimetric method was found to be ≤0.6 mg/day.

### Example 5

In the first step, an aqueous solution of poly(ethylene oxide)-block-poly(propylene oxide)-block-poly(ethylene oxide) (PEO-PPO-PEO) (Pluronic® L64 (BASF)) would be prepared by mixing 50 g of the block co-polymer in 50 g water. The solution would be mixed for 3 hr using a magnetic stirrer at 300 rpm.

In the second step, 50 g of bio-pesticide would be added to 50 g of mineral oil.

In the third step, the mixture obtained from the second step would be added to the mixture obtained from the first step at room temperature to form the bio-pesticide encapsulated in the amphiphilic material.

5 grams of the product obtained from third step, would be spray applied to 250 grams of soybean seed and dried at 70 deg C. for 1 minute to form a uniform coating on the seed.

### Example 6

In the first step, an aqueous solution of poly(ethylene oxide)-block-poly(propylene oxide)-block-poly(ethylene oxide) (PEO-PPO-PEO) (Pluronic® L64 (BASF)) would be prepared by mixing 50 g of a non-ionic diblock copolymer prepared by reacting mono hydroxy polyethylene oxide with linolenic acid in 50 g water. The solution would be mixed for 3 hr using a magnetic stirrer at 300 rpm.

In the second step, 50 g of Bacillus thrungiensis would be added to 50 g of soybean oil methyl ester

In the third step, the mixture obtained from the second step would be added to the mixture obtained from the first step at room temperature to form the bio-pesticide encapsulated in the amphiphilic material.

5 grams of the product obtained from third step, would be spray applied to 250 grams of soybean seed and dried at 70 deg C. for 1 minute to form a uniform coating on the seed.

By about, we mean within 10% of the value, or within 5%, or within 1%.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

1. A coated seed, plant, or soil comprising:
the seed, plant or soil coated with an encapsulated composition comprising:
a plurality of capsules each comprising an amphiphilic material encapsulating an agrochemical, the encapsulated agrochemical having a release rate less than a release rate of unencapsulated agrochemical.

2. The coated seed, plant, or soil of claim 1 wherein the agrochemical comprises at least one of pesticides, herbicides, fungus, and bacteria.

3. The coated seed, plant, or soil of claim 1 wherein the agrochemical comprises an agrochemical.

4. The coated seed, plant, or soil of claim 3 wherein the agrochemical is at least one of allethrin, permethrin, transfluthrin, tefluthrin, metofluthrin, fenfluthrin, kadethrin, neopynamins, prallethrin, vapothrin, esbiothrin, dichlovos, deltamethrin, and cypermethrin.

5. The coated seed, plant, or soil of claim 1 wherein the amphiphilic material is a polymer.

6. The coated seed, plant, or soil of claim 5 wherein the polymer is a copolymer.

7. The coated seed, plant, or soil of claim 1 wherein the amphiphilic material is a graft copolymer, a modified N,N,N′,N′-Tetrakis(2-hydroxypropyl)ethylenediamine, a cationic nanoparticle, a diblock or triblock copolymer, an ionic or nonionic surfactant, a low surface energy silica, a Guerbet ester, or a poly(stearyl methacrylate-co-acrylic acid).

8. The coated seed, plant, or soil of claim 1 wherein the amphiphilic material has hydrophilic and hydrophobic portions, and wherein the hydrophilic portion anchors the encapsulated substance and the hydrophobic portion forms a shell wall of the capsule.

9. The coated seed, plant, or soil of claim 1 wherein the amphiphilic material has a hydrophilic-lipophilic balance within a range of from about 1 to about 20.

10. The coated seed, plant, or soil of claim 1 wherein the capsules are stable at alkaline pH.

11. The coated seed, plant, or soil of claim 1 wherein the amphiphilic polymer is at least one of a diblock copolymer, a triblock copolymer, and a nonionic surfactant, and wherein the amphiphilic polymer is capable of forming a micelle around the agrochemical when the capsule is dispersed in a liquid.

12. The coated seed, plant, or soil of claim 1 wherein the amphiphilic material is an amphiphilic polymer and wherein the amphiphilic polymer is capable of forming a micelle around the agrochemical when the capsule is dispersed in a liquid.

13. The coated seed, plant, or soil of claim 1 wherein the amphiphilic material is an amphiphilic polymer and wherein the amphiphilic polymer forms a film onto the seed, plant, or soil when applied and dried.

14. The coated seed, plant, or soil of claim 11 wherein the capsules have a critical micelle concentration within a range of from about 0.0001 wt % to about 50 wt %.

15. The coated seed, plant, or soil of claim 11 wherein the agrochemical is transfluthrin and wherein the amphiphilic material is a poly(ethylene oxide)-poly(propylene oxide)-poly(ethylene oxide) triblock copolymer.

16. The coated seed, plant, or soil of claim 11 wherein the agrochemical is bio pesticide and wherein the amphiphilic material is non-ionic diblock copolymer prepared by reacting mono hydroxy polyethylene oxide with linolenic acid.

17. The coated seed, plant, or soil of claim 11 wherein the bio pesticide comprises bacillus thrungiensis.

18. The coated seed, plant, or soil of claim 1 wherein the encapsulated composition further comprises at least one additive.

19. The coated seed, plant, or soil of claim 1 wherein the at least one additive comprises solvents, gum Arabic, waxes, commercially available stickers, binders, surfactants, oils, and salts.

20. A method of reducing a rate of release of an agrochemical from a seed, plant, or soil comprising:
coating the seed, plant, or soil with an encapsulated composition comprising:
A plurality of capsules each comprising an amphiphilic material encapsulating an agrochemical, the encapsulated agrochemical having a rate of release less than a rate of release of unencapsulated agrochemical.
